(19) United States
(12) Patent Application Publication
(10) Pub. No.: US 2026/0320246 A1
(43) Pub. Date: Oct. 15, 2026

(54) METHOD AND SYSTEM FOR CONSTRUCTING MULTI-ENERGY COUPLING NORMALIZATION MODEL, AND MEDIUM

(71) Applicant: Shandong University, Jinan (CN)

(72) Inventors: Yibao JIANG, Jinan (CN); Zhenyu YU, Jinan (CN); Haoran ZHAO, Jinan (CN)

(73) Assignee: Shandong University, Jinan (CN)

(21) Appl. No.: 19/444,244

(22) Filed: Jan. 9, 2026

(30) Foreign Application Priority Data
Apr. 9, 2025 (CN) 2025104363021

(51) Int. Cl. G06F 30/20; G06F 111/04

(52) U.S. Cl. CPC G06F 30/20; G06F 2111/04

(57) ABSTRACT

The present disclosure relates to a method and system for constructing a multi-energy coupling normalization model, and a medium. The method includes the following steps: step S1: selecting independent reference values for constructing a multi-energy coupling normalization model and setting parameters, obtaining an actual value corresponding to each parameter, and based on the reference values and the actual values, normalizing the actual values to obtain a normalized value of each parameter; step S2: establishing an initial target model with a goal of minimizing overall energy cost, and generating a multi-energy coupling normalization initial model by combining the normalized value of each parameter in step S1 with the initial target model; step S3: calculating dynamic balance factors of a heat supply network and a water return network; and; step S4: based on the dynamic balance factors, modifying the multi-energy coupling normalization initial model to obtain the multi-energy coupling normalization model.

### CROSS-REFERENCE TO RELATED APPLICATIONS

The application claims priority to Chinese patent application No. 2025104363021, filed on Apr. 9, 2025, the entire contents of which are incorporated herein by reference.

### TECHNICAL FIELD

The present disclosure belongs to the technical field of energy management, specifically relating to a method and system for constructing a multi-energy coupling normalization model, and a medium.

### BACKGROUND

With continuous development of energy systems, integrated energy systems have gradually become a hot topic in research and application. The integrated energy systems achieve efficient energy utilization and complementarity by integrating multiple energy forms such as electric power and heat. In modern energy systems, the multi-energy integration of the integrated energy systems (IES) is a key link in achieving efficient energy utilization and is of great significance for promoting energy transformation and achieving the “dual carbon” goal.

In the prior art, electric power systems widely adopt normalization methods to improve the computational efficiency by normalizing parameters such as voltage and power. Normalization systems achieve numerical consistency and simplify calculations by normalizing physical quantities with different dimensions, such as voltage, current, and power, in electric power systems to a unified dimension. It has significant advantages in electric power system analysis, such as improving the numerical stability of power flow calculations and facilitating the adjustment of controller parameters.

However, existing normalization systems are mainly used in the electric power industry. For the IES, which involves multiple different physical systems such as electric power, thermal, and natural gas systems, and whose parameters vary greatly, the existing normalization systems cannot be directly applied to modeling and optimization of the IES. Existing modeling methods for the IES often require separate modeling of the electric power, thermal, and natural gas systems before coupling. This approach is not only computationally complex but also fails to intuitively reflect an operating state of the overall system, hindering global system optimization and real-time monitoring. Traditional normalization is only applicable to single-energy systems and cannot solve the following problems: cross-system parameter coupling: temperature and pressure intensity differences in heat supply/water return and gas supply networks of thermal and natural gas systems are significant (pressure is usually in the megapascal range and temperature is usually in the tens of degrees Celsius range), and a single normalization reference leads to the failure of normalization; high model complexity: electric-thermal-gas systems need to be modeled separately and then coupled, resulting in computational redundancy and difficulty in reflecting a global state; limitations of a variable flow mode: traditional methods struggle to handle flow rate-temperature strong coupling constraints, and are prone to getting trapped in local optima or failing to converge.

### SUMMARY

To solve the problems in the prior art, the present disclosure provides a method and system for constructing a multi-energy coupling normalization model, and a medium. The present disclosure solves the problems of computational redundancy, difficulty in reflecting a global state, and proneness to getting trapped in local optima or failing to converge that exist in the prior art when normalizing multiple energy systems separately in an integrated energy system.

The technical solution adopted in the present disclosure is as follows:

In a first aspect, the present application provides a method for constructing a multi-energy coupling normalization model, including the following steps:
step S1: selecting independent reference values for constructing a multi-energy coupling normalization model and setting parameters, obtaining an actual value corresponding to each parameter, and based on the reference values and the actual values, normalizing the actual values to obtain a normalized value of each parameter;
step S2: establishing an initial target model with a goal of minimizing overall energy cost, and generating a multi-energy coupling normalization initial model by combining the normalized value of each parameter in step S1 with the initial target model;
step S3: calculating dynamic balance factors of a heat supply network and a water return network; and
step S4: based on the dynamic balance factors, modifying the multi-energy coupling normalization initial model to obtain the multi-energy coupling normalization model.

Preferably, in step S1, the reference values include the independent reference values and derived reference values, and the selected independent reference values are as follows: power S, voltage squared value V, mass flow rate m, thermal water supply temperature T^{S}, thermal water return temperature T^{R}, thermal water supply pressure intensity P^{S}, thermal water return pressure intensity P^{R}, natural gas temperature T^{G}, and natural gas pressure intensity P^{G};
calculation formulas of the derived reference values are as follows:

$$\begin{matrix}Z = V / S \\ I = {S}^{2} / V \\ {T}^{loss} = m \\ c = S / ( {mT}^{S} ) \\ Ψ = Γ = {P}^{S} / {m}^{2} \\ ρ = {mP}^{S} / S \\ Ω = ( {T}^{G} \cdot {m}^{2} ) / {( {P}^{G} )}^{2} \\ κ = m\end{matrix}$$

where: Z is impedance, I is a current squared value, T^{loss} is a thermal temperature loss factor, c is a specific heat capacity, Ψ is a thermal pipeline friction factor, Γ is a thermal heat exchanger fiction factor, ρ is a thermal water density, Ω is a natural gas pressure constant, and κ is a natural gas temperature constant.

Preferably, in step S2, the initial target model is represented as:

minJ=αC+βG
where: C is the quantity of coal, G is the quantity of natural gas, α is a price per unit of coal, and β is a price per unit of natural gas;
constraints are established in the initial target model:
power grid side: including node power balance, voltage/current limits, and line power flow constraints, represented as:

$$\begin{matrix}{P}_{j , t} = {\sum }_{k : j \to k} {P}_{jk , t} - {\sum }_{i : i \to j} ( {P}_{ij , t} - {r}_{ij} {l}_{ij , t} ) , k ∈ ℜ , i ∈ ℵ \\ {Q}_{j , t} = {\sum }_{k j \to k} {Q}_{jk , t} - {\sum }_{i : i \to j} ( {Q}_{lj , t} - {x}_{ij} {l}_{ij , t} ) , k ∈ ℜ , i ∈ ℵ \\ {v}_{j , t} = {v}_{i , t} - 2 ( {r}_{ij} {P}_{ij , t} + {x}_{ij} {Q}_{ij , t} ) + ( {r}_{ij}^{2} + {x}_{ij}^{2} ) {l}_{ij , t} \\ {‖ \begin{matrix}2 {P}_{ij , t} \\ 2 {Q}_{ij , t} \\ {l}_{ij , t} - {v}_{i , t}\end{matrix} ‖}_{2} \leq {l}_{ij , t} + {v}_{i , t} \\ {\underline{v}}_{l} \leq {v}_{j , t} \leq {\overline{v}}_{j} \\ 0 \leq {l}_{ij , t} \leq {\overline{l}}_{ij , t} \\ {P}_{j , t} = {P}_{j , t}^{C} + {P}_{j , t}^{G} - {P}_{j , t}^{D} \\ {Q}_{j , t} = {Q}_{j , t}^{C} + {Q}_{j , t}^{G} - {P}_{j , t}^{D} \\ {\underline{P}}_{j , t}^{C , G} \leq {P}_{j , t}^{C , G} \leq {\overline{P}}_{j , t}^{C , G} \\ {\underline{Q}}_{j , t}^{C , G} \leq {Q}_{j , t}^{C , G} \leq {\overline{Q}}_{j , t}^{C , G}\end{matrix}$$

where: P_{j,t} is an active power of node j at time t, P_{jk,t} is an active power flowing from node j to node k, P_{ij,t} is an active power flowing from node i to node j, rᵢⱼ is resistance of a line connecting nodes i and j, l_{ij,t} is a square of a current value of the line connecting nodes i and j at time t, [symbol] is a set of nodes from which the power flows out of node j, and [symbol] is a set of nodes from which the power flows to node j;
Q_{j,t} is a reactive load of node j at time t, Q_{jk,t} is a reactive power flowing from node j to node k, Q_{ij,t} is a reactive power flowing from node i to node j, and xᵢⱼ is reactance on the line connecting nodes i and j;
v_{i,t} is a square of a voltage value of node i at time t, and v_{j,t} is a square of a voltage value of node j at time t;
vⱼ is a lower limit of the squared value of the voltage; v̅ⱼ is an upper limit of the squared value of the voltage;
l̅_{ij,t} is a squared value of a maximum current on line ij;

$${P}_{j , t}^{C}$$

is active energy generated by node j consuming the coal at time t,

$${P}_{j , t}^{G}$$

is active energy generated by node j consuming the natural gas at time t, and

$${P}_{j , t}^{D}$$

is an active load capacity of node j at time t;

$${Q}_{j , t}^{C}$$

is reactive energy generated by node j consuming the coal at time t,

$${Q}_{j , t}^{G}$$

is reactive energy generated by node j consuming the natural gas at time t, and

$${Q}_{j , t}^{D}$$

is a reactive load capacity of node j at time t;

$${\underline{P}}_{j , t}^{C}$$

is a lower limit of the active energy generated by an electric generator of node j at time t through the coal,

$${\overline{P}}_{j , t}^{C}$$

is an upper limit of the active energy generated by the electric generator of node j at time t through the coal,

$${\underline{P}}_{j , t}^{G}$$

is a lower limit of the active energy generated by the electric generator of node j at time t through the natural gas, and

$${\overline{P}}_{j , t}^{G}$$

is an upper limit of the active energy generated by the electric generator of node j at time t through the natural gas;

$${\underline{Q}}_{j , t}^{C}$$

is a lower limit of the reactive energy generated by the electric generator of node j at time t through the coal,

$${\overline{Q}}_{j , t}^{C}$$

is an upper limit of the reactive energy generated by the electric generator of node j at time t through the coal,

$${\underline{Q}}_{j , t}^{G}$$

is a lower limit of the reactive energy generated by the electric generator of node j at time t through the natural gas, and

$${\overline{Q}}_{j , t}^{G}$$

is an upper limit of the reactive energy generated by the electric generator of node j at time t through the natural gas;
heat supply network side: including mass flow conservation, temperature-pressure coupling equations, and heat exchanger efficiency constraints, represented as:

$${m}_{k , t}^{i n} - {m}_{k , t}^{out} = {\sum }_{l : k \to l} {m}_{kl , t} - {\sum }_{j : j \to k} {m}_{jk , t}$$

$${P}_{k , t}^{S} - {P}_{l , t}^{S} = {Ψ}_{k l} {m}_{kl , t}^{2}$$

$${P}_{l , t}^{R} - {P}_{k , t}^{R} = {Ψ}_{l k} {m}_{lk , t}^{2}$$

$${P}_{k ,}^{S} - {P}_{k , t}^{R} = {{Ψ}_{k} ( {m}_{k , t}^{out} )}^{2}$$

$$Δ H = c \cdot {m}_{k , t}^{out} \cdot ( {T}_{k , t}^{S} - {T}_{k , t}^{R} )$$

$${\underline{m}}_{kl , t} \leq {m}_{kl , t} \leq {\overline{m}}_{kl , t}$$

$$\underline{m} \leq {m}_{k , t}^{in , out} \leq \overline{m}$$

$${\underline{P}}_{k}^{S , R} \leq {P}_{k}^{S , R} \leq {\overline{P}}_{k}^{S , R}$$

$${\underline{T}}_{k}^{S , R} \leq {T}_{k}^{S , R} \leq {\overline{T}}_{k}^{S , R}$$

where

$${m}_{k , t}^{in} , {m}_{k , t}^{out}$$

are mass flow rates of injected water and outflow water at node k at time t, respectively; and m_{kl,t}, m_{jk,t} are a mass flow rate of the water flowing in a pipeline from node k to node l at time t and a mass flow rate of the water flowing in the pipeline from node j to node k at time t, respectively;
flowing of the water between nodes in a heat supply pipeline is driven by a pressure intensity, and a pressure intensity difference between the nodes determines the mass flow rate in the pipeline; wherein

$${P}_{k , t}^{S} , {P}_{l , t}^{S}$$

are pressure intensities of nodes k and I in a water supply pipeline at time t, respectively, Ψₖₗ represents a friction factor of pipeline kl, and m_{kl,t} represents the mass flow rate of the water in pipeline kl at time t;

$${P}_{k , t}^{R} , {P}_{l , t}^{R}$$

are pressure intensities at nodes k and l in a water return pipeline at time t, respectively, Ψₗₖ represents a friction factor of pipeline lk, and m_{lk,t} represents the water mass flow rate of pipeline lk at time t;

$${P}_{k , t}^{S} , {P}_{k , t}^{R}$$

are pressure intensities at node k in water supply and water return networks at time t, respectively, and Ψₖ is the pipeline friction factor;
ΔH is exchanged heat; constraints of upper and lower limits of the mass flow rate of water flow passing through the pipeline: m_{kl,t}, m̅_{kl,t} are a lower limit and an upper limit of the mass flow rate of the water flow passing through the pipeline, respectively;
constraints of upper and lower limits of the mass flow rate of the water flow at injection and outflow nodes: m, m̅ are a lower limit and an upper limit of the mass flow rate, respectively;

$${\underline{P}}_{k}^{S} , {\overline{P}}_{k}^{S}$$

are a lower limit and an upper limit of the pressure intensity at heat supply node k, respectively; and

$${\underline{P}}_{k}^{R} , {\overline{P}}_{k}^{R}$$

are a lower limit and an upper limit of the pressure intensity at water return node k, respectively;

$${\underline{T}}_{k}^{S} , {\overline{T}}_{k}^{S}$$

are a lower limit and an upper limit of the temperature at heat supply node k, respectively; and

$${\underline{T}}_{k}^{R} {\overline{T}}_{k}^{R}$$

are a lower limit and an upper limit of the temperature at water return node k, respectively;
gas network side: including a temperature drop equation, a flow conservation equation, and a pipeline pressure intensity equation, represented as:

$$\begin{matrix}( {T}_{i} + {T}_{j} ) {f}_{ij}^{2} = ( {P}_{i}^{2} - {P}_{j}^{2} ) Ω \\ \frac{( {T}_{j}^{out} - {T}_{i}^{in} ) {f}_{ij}}{l} + \frac{1}{2} κ ( {T}_{i}^{in} + {T}_{j}^{out} ) - κ {T}_{e} = 0 \\ \sum {f}_{s} + {\sum }_{j : j \to i} {f}_{ji} = \sum {f}_{D} + {\sum }_{i : i \to k} {f}_{ik} \\ {T}_{j} \cdot {\sum }_{i : i \to j} {f}_{ij} = {\sum }_{i : i \to j} ( {f}_{ij} {T}_{j}^{out} ) \\ {\underline{f}}_{ij} \leq {f}_{ij} \leq {\overline{f}}_{ij} \\ \underline{P} \leq {P}_{i} \leq \overline{P}\end{matrix}$$

Tᵢ and Pᵢ represent the temperature and pressure intensity at node i, respectively;

$${T}_{j}^{out}$$

and

$${T}_{i}^{in}$$

represent the temperatures at which the natural gas enters and exits a pipeline, respectively; fᵢⱼ is a natural gas flow rate of the pipeline from node i to node j; 1 is the length of the natural gas pipeline, and Tₑ is an environment (soil) temperature outside the pipeline;
fₛ, fⱼᵢ, f_{D}, fᵢₖ are the natural gas injected at node i, a mass flow rate flowing from node j to node i, a natural gas load capacity at node i, and a natural gas mass flow rate flowing from node i to node k, respectively;
fᵢⱼ, f̅ᵢⱼ are an lower limit and an upper limit of the natural gas mass flow rate of the pipeline (i, j), respectively;
P, P̅ are a lower limit and an upper limit of the pressure intensity at node i, respectively;
where: a heat exchange equation is: ΔH=c·m·(T^{S}−T^{R}); a pressure intensity balance equation for a water supply pipeline is: P^{S}−P^{R}=Ψm².

Preferably, in step S3, a normalized heat exchange equation is: ΔĤ=ĉ·\hat{m}·(\hat{T}^{S}−\hat{T}^{R}); a normalized pressure intensity balance equation for a water supply pipeline is: \hat{P}^{S}−\hat{P}^{R}=\hat{Ψ}\hat{m}²;
where: ĉ is a normalized specific heat capacity, \hat{m} is a normalized mass flow rate, \hat{T}^{S} is a normalized thermal water supply temperature, \hat{T}^{R} is a normalized thermal water return temperature, \hat{P}^{S} is a normalized thermal water supply pressure intensity, \hat{P}^{R} is a normalized thermal water return pressure intensity, and \hat{Ψ} is a normalized water supply pipeline friction factor.

Preferably, in step S4, the dynamic balance factors include a temperature balance factor σ and a pressure balance factor

$$φ , σ = \frac{{τ}^{S}}{{T}^{R}} , ϕ = \frac{{P}^{R}}{{P}^{S}} ;$$

a coupled heat exchange equation is: ΔĤ=ĉ·\hat{m}·(\hat{T}^{S}−σ\hat{T}^{R}); a coupled pressure intensity balance equation for the water supply pipeline is: \hat{P}^{S}−φ\hat{P}^{R}=\hat{Ψ}\hat{m}².

Preferably, in step S2, the natural gas flows from node i to node j, and a natural gas pressure intensity equation is:

$$( {T}_{i} + {T}_{j} ) {f}_{ij}^{2} = ( {p}_{i}^{2} - {p}_{j}^{2} ) Ω$$

where: Tᵢ is the temperature of node i, Tⱼ is the temperature of node j, pᵢ is the pressure intensity of node i, pⱼ is the pressure intensity of node j, and fᵢⱼ is the natural gas flow rate of the pipeline from node i to node j.

Preferably, a normalized natural gas pressure intensity equation is

$$( {\hat{T}}_{i} + {\hat{T}}_{j} ) {\hat{f}}_{ij}^{2} = ( {\hat{p}}_{i}^{2} - {\hat{p}}_{j}^{2} ) \hat{Ω}$$

where: \hat{T}ᵢ is a normalized temperature of node i, \hat{T}ⱼ is a normalized temperature of node j, \hat{p}ᵢ is a normalized pressure intensity of node i, \hat{p}ⱼ is a normalized pressure intensity of node j, \hat{f}ᵢⱼ is a normalized natural gas flow rate of the pipeline from node i to node j, and \hat{Ω} is a normalized natural gas pressure intensity constant.

Preferably, in step S1, a calculation formula of the normalized value is

$$normalized value = \frac{actual value}{independent reference value ( derived reference value )} .$$

In a second aspect, the present application provides a system for constructing a multi-energy coupling normalization model, including:
an acquisition unit, used to acquire actual values;
a calculation unit, used to calculate derived reference values, normalized values, and dynamic balance factors;
a first modeling unit, used to construct an initial target model according to independent reference values and the derived reference values;
a second modeling unit, used to generate a multi-energy coupling normalization initial model according to the initial target model and the normalized values; and
a third modeling unit, used to generate a multi-energy coupling normalization model according to the normalization model and the dynamic balance factors.

In a third aspect, the present application provides a computer-readable storage medium, including a stored program, wherein, when the program is running, a device where the computer-readable storage medium is located is controlled to execute the method for constructing the multi-energy coupling normalization model described in the first aspect.

According to the above technical solutions, the present disclosure has the following advantages:

### 1. Cross-System Normalization:

By introducing the global normalization method, the present disclosure can normalize various physical quantities (such as voltage, current, pressure, temperature, etc.) in electric power, thermal and natural gas systems to the same dimensions, thereby achieving unified modeling of the electric power, thermal and natural gas systems. This method is not only applicable to fixed flow modes, but can also flexibly handle complex optimization problems in variable flow modes.

### 2. Improvement of Numerical Consistency and Computational Efficiency:

The present disclosure normalizes various parameters and variables in the system, significantly reducing differences in numerical ranges and improving numerical consistency and computational stability of the model. In solution of an optimal energy flow (OEF) problem, the present disclosure can significantly reduce the number of computational iterations, reduce the solution time, and improve the solution efficiency.

### 3. Enhanced State Visualization:

The present disclosure can uniformly model the IES, normalize the system operating state to a numerical range close to 1, and intuitively reflect the system operating state. For example, by using normalized temperature and pressure values, it is possible to quickly determine whether the heat supply and water return networks of the thermal system are in normal operating state, which facilitates real-time monitoring and fault diagnosis of the system.

### 4. Mode Universality:

By introducing auxiliary balance variables, the present disclosure can flexibly handle the temperature and pressure intensity differences of different networks in the thermal system and adapt to various operating modes such as a fixed flow mode and a variable flow mode. Whether in linear optimization problems (such as the OEF problem under a fixed flow mode) or nonlinear optimization problems (such as the OEF problem under a variable flow mode), the present disclosure can significantly improve the solution efficiency and ensure the accuracy and stability of the solution.

In summary, the unified normalization method for integrated energy systems of the present disclosure is significantly superior to the prior art in terms of modeling framework unifying, numerical consistency and computational efficiency, intuitiveness of system operating states, and adaptability to multiple operating modes and optimization problems. The present disclosure provides a more efficient, stable and intuitive modeling and optimization method for integrated energy systems that integrate electric power and thermal systems.

### BRIEF DESCRIPTION OF DRAWINGS

To more clearly illustrate the technical solution of the present disclosure, the accompanying drawings used in the description will be briefly introduced below. Obviously, the accompanying drawings described below are only some embodiments of the present disclosure. For those of ordinary skill in the art, other drawings can be obtained based on these drawings without creative effort.

FIG. 1 is a flowchart of a construction method in a specific implementation embodiment of the present disclosure;

FIG. 2 is a schematic diagram of a construction method in a specific implementation embodiment of the present disclosure; and

FIG. 3 is a comparison diagram of heat supply network states before and after normalization in a specific implementation embodiment of the present disclosure.

### DETAILED DESCRIPTION OF THE EMBODIMENTS

Various embodiments of this disclosure will be described more fully in the following detailed description. This disclosure may have various embodiments, and adjustments and changes may be made therein. However, it should be understood that: there is no intention to limit the various embodiments of this disclosure to the specific embodiments disclosed herein, but rather this disclosure should be understood to cover all modifications, equivalents and/or alternatives that fall within the spirit and scope of the various embodiments of this disclosure.

The following is a definition of some terms used in this solution to facilitate a better understanding of the solution:

### 1. IES (Integrated Energy Systems)

An integrated energy system (IES) refers to a system that integrates multiple energy forms (such as electric power, thermal energy, cold energy, and gas) with energy storage and conversion facilities, and achieves efficient energy utilization, interconnection, and flexible dispatch through optimized management and control. It combines renewable energy, traditional energy and energy storage technologies to address challenges in energy supply, consumption and environmental impact. Integrated energy systems emphasize coordinated energy dispatch and intelligent control to achieve efficient, low-carbon, and green energy development, and promote the modernization and sustainability of energy systems. The system has wide applications in smart grids, distributed energy, microgrids and other fields, aiming to improve energy efficiency, reduce costs and reduce greenhouse gas emissions.

### 2. Independent Reference Value

An independent reference value is a standard value that is selected during measurement or calculation and does not depend on any other variable or reference system, and is independent by definition. It is usually a reference value obtained through experiments or high-precision measurement techniques, serving as a reference for other relevant data. The independent references are widely used in scientific research, engineering experiments, and standardized testing to ensure the comparability and consistency of different devices and systems under the same conditions.

### 3. Derived Reference Value

A derived reference value is a reference value calculated from one or more independent reference values. In some cases, actual measurements may not be able to directly obtain certain reference values. Therefore, new derived reference values are obtained by using known independent reference values and related formulas or derivation methods. This method is often used in multivariate measurements or calibration of complex systems, where the accuracy of the derived reference value directly affects the reliability of the final result.

### 4. Normalization

Normalization refers to transforming values of different orders of magnitude or scales into uniform standardized values in a certain way, so that the data can be compared on the same scale. Common normalization methods include mapping data linearly to a specific interval (such as [0,1]) or standardizing the same by subtracting the mean or dividing by the standard deviation. Normalization is widely used in data analysis, machine learning, signal processing, and other fields. It can effectively eliminate the influence of dimensions and improve the efficiency and accuracy of models.

To solve the problems in the prior art, the present disclosure provides a method and system for constructing a multi-energy coupling normalization model, and a medium. The present disclosure solves the problems of computational redundancy, difficulty in reflecting a global state, and proneness to getting trapped in local optima or failing to converge that exist in the prior art when normalizing multiple energy systems separately in an integrated energy system.

### Embodiment 1

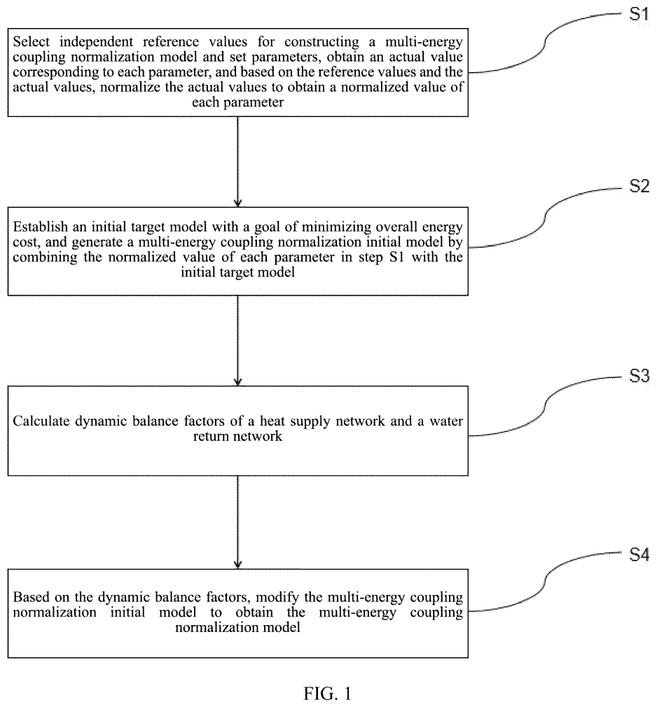

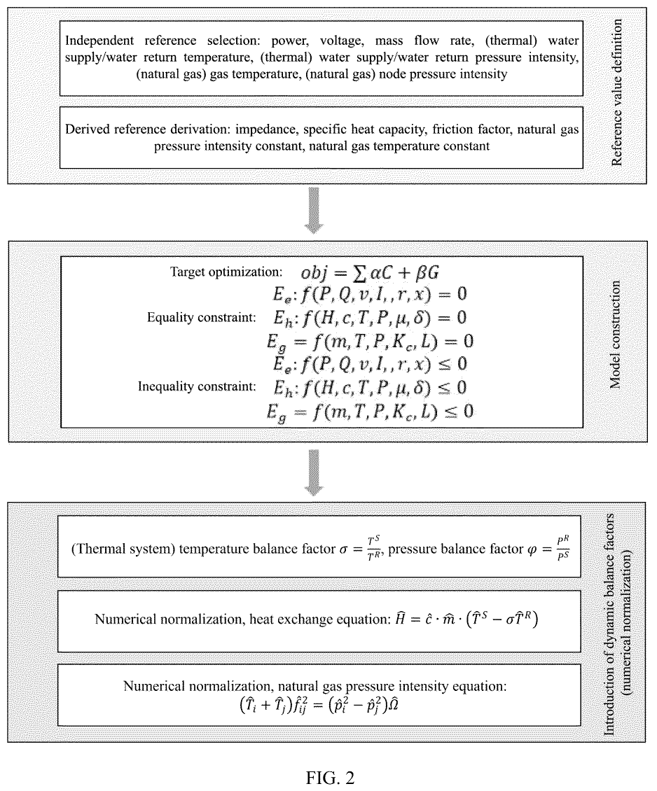

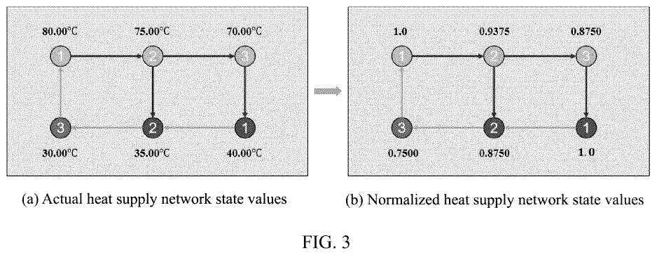

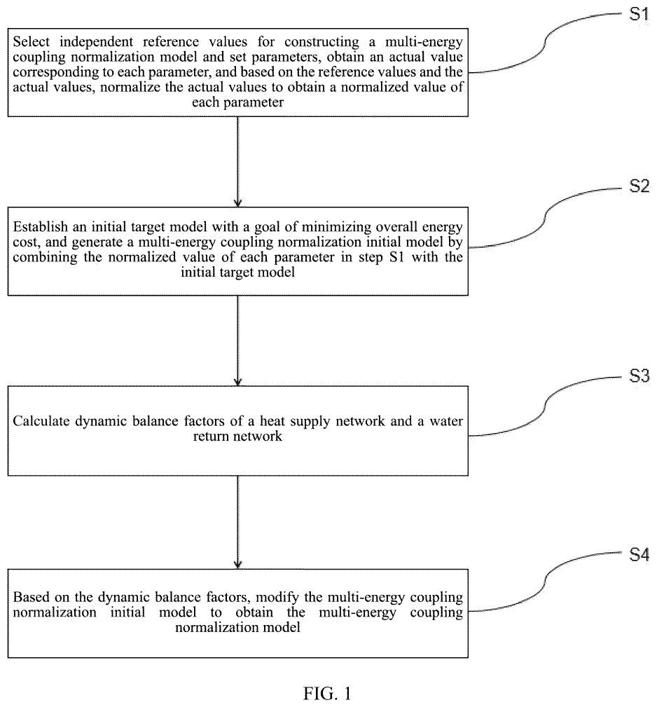

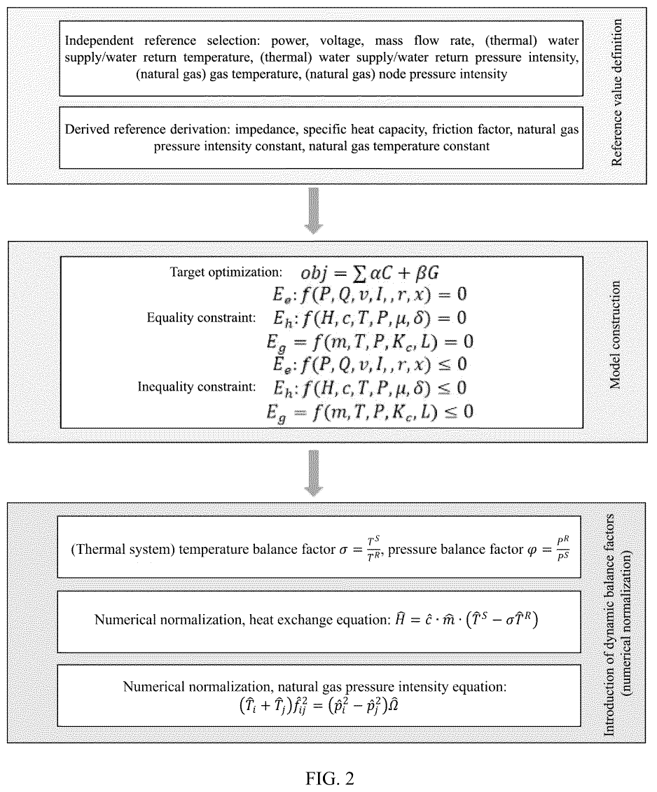

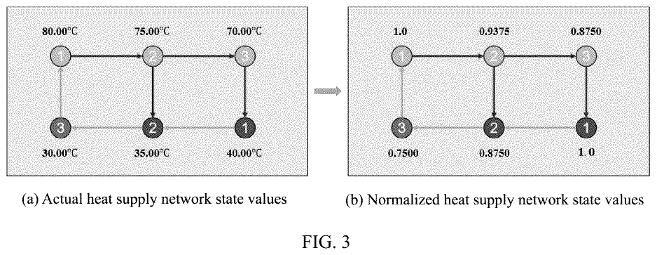

To solve the problems in the prior art, the present disclosure provides a method for constructing a multi-energy coupling normalization model, as shown in FIG. 1 to FIG. 3, including the following steps.

Step S1: selecting independent reference values for constructing a multi-energy coupling normalization model and setting parameters, obtaining an actual value corresponding to each parameter, and based on the reference values and the actual values, normalizing the actual values to obtain a normalized value of each parameter;
in step S1, the reference values include the independent reference values and derived reference values, and the selected independent reference values are as follows: power S, voltage squared value V, mass flow rate m, thermal water supply temperature T^{S}, thermal water return temperature T^{R}, thermal water supply pressure intensity P^{S}, thermal water return pressure intensity P^{R}, natural gas temperature T^{G}, and natural gas pressure intensity P^{G};
calculation formulas of the derived reference values are as follows:

$$\begin{matrix}Z = V / S \\ I = {S}^{2} / V \\ {T}^{loss} = m \\ c = S / ( {mT}^{S} ) \\ Ψ = Γ = {P}^{S} / {m}^{2} \\ ρ = {mP}^{s} / S \\ Ω = ( {T}^{G} \cdot {m}^{2} ) / {( {P}^{G} )}^{2} \\ κ = m\end{matrix}$$

where: Z is impedance, I is a current squared value, T^{loss} is a thermal temperature loss factor, c is a specific heat capacity, Ψ is a thermal pipeline friction factor, Γ is a thermal heat exchanger fiction factor, ρ is a thermal water density, Ω is a natural gas pressure constant, and x is a natural gas temperature constant;
during normalization of the actual value, the following formula is used for calculation:

$$normalized value = \frac{actual value}{independent reference value ( derived reference value )} .$$

Step S2: establishing an initial target model with a goal of minimizing overall energy cost, and generating a multi-energy coupling normalization initial model by combining the normalized value of each parameter in step S1 with the initial target model;
the initial target model is represented as:

$$min J = α C + β G$$

where: C is the quantity of coal, G is the quantity of natural gas, α is a price per unit of coal, and β is a price per unit of natural gas;
a heat exchange equation is: ΔH=c·m·(T^{S}−T^{R}); a pressure intensity balance equation for a water supply pipeline is: P^{S}−P^{R}=Ψm².

### Establishment of Constraints:

power grid side: including node power balance, voltage/current limits, and line power flow constraints, represented as:

$$\begin{matrix}{P}_{j , t} = {\sum }_{k : j \to k} {P}_{jk , t} - {\sum }_{i : i \to j} ( {P}_{ij , t} - {r}_{ij} {l}_{ij , t} ) , k ∈ ℜ , i ∈ ℵ \\ {Q}_{j , t} = {\sum }_{k : j \to k} {Q}_{jk , t} - {\sum }_{i : i \to j} ( {Q}_{ij , t} - {x}_{ij} {l}_{ij , t} ) , k ∈ ℜ , i ∈ ℵ \\ {v}_{j , t} = {v}_{i , t} - 2 ( {r}_{ij} {P}_{ij , t} + {x}_{ij} {Q}_{ij , t} ) + ( {r}_{ij}^{2} + {x}_{ij}^{2} ) {l}_{ij , t} \\ {‖ \begin{matrix}2 {P}_{ij , t} \\ 2 {Q}_{ij , t} \\ {l}_{ij , t} - {v}_{i , t}\end{matrix} ‖}_{2} \leq {l}_{ij , t} + {v}_{i , t} \\ {\underline{v}}_{j} \leq {v}_{j , t} \leq {\overline{v}}_{j} \\ 0 \leq {l}_{ij , t} \leq {\overline{l}}_{ij , t} \\ {P}_{j , t} = {P}_{j , t}^{C} + {P}_{j , t}^{G} - {P}_{j , t}^{D} \\ {Q}_{j , t} = {Q}_{j , t}^{C} + {Q}_{j , t}^{G} - {P}_{j , t}^{D} \\ {\underline{P}}_{j , t}^{C , G} \leq {P}_{j , t}^{C , G} \leq {\overline{P}}_{j , t}^{C , G} \\ {\underline{Q}}_{j , t}^{C , G} \leq {Q}_{j , t}^{C , G} \leq {\overline{Q}}_{j , t}^{CG}\end{matrix}$$

where: P_{j,t} is an active power of node j at time t, P_{jk,t} is an active power flowing from node j to node k, P_{ij,t} is an active power flowing from node i to node j, rᵢⱼ is resistance of a line connecting nodes i and j, l_{ij,t} is a square of a current value of the line connecting nodes i and j at time t, [symbol] is a set of nodes from which the power flows out of node j, and [symbol] is a set of nodes from which the power flows to node j;
Q_{j,t} is a reactive load of node j at time t, Q_{jk,t} is a reactive power flowing from node j to node k, Q_{ij,t} is a reactive power flowing from node i to node j, and xᵢⱼ is reactance on the line connecting nodes i and j;
v_{i,t} is a square of a voltage value of node i at time t, and v_{j,t} is a square of a voltage value of node j at time t;
vⱼ is a lower limit of the squared value of the voltage; v̅ⱼ is an upper limit of the squared value of the voltage;
l̅_{ij,t} is a squared value of a maximum current on line ij;

$${P}_{j , t}^{C}$$

is active energy generated by node j consuming the coal at time t,

$${P}_{j , t}^{G}$$

is active energy generated by node j consuming the natural gas at time t, and

$${P}_{j , t}^{D}$$

is an active load capacity of node j at time t;

$${Q}_{j , t}^{C}$$

is reactive energy generated by node j consuming the coal at time t,

$${Q}_{j , t}^{G}$$

is reactive energy generated by node j consuming the natural gas at time t, and

$${Q}_{j , t}^{D}$$

is a reactive load capacity of node j at time t;

$${\underline{P}}_{j , t}^{C}$$

is a lower limit of the active energy generated by an electric generator of node j at time t through the coal,

$${\overline{P}}_{j , t}^{C}$$

is an upper limit of the active energy generated by the electric generator of node j at time t through the coal,

$${\underline{P}}_{j , t}^{G}$$

is a lower limit of the active energy generated by the electric generator of node j at time t through the natural gas, and

$${\overline{P}}_{j , t}^{G}$$

is an upper limit of the active energy generated by the electric generator of node j at time t through the natural gas;

$${\underline{Q}}_{j , t}^{C}$$

is a lower limit of the reactive energy generated by the electric generator of node j at time t through the coal,

$${\overline{Q}}_{j , t}^{C}$$

is an upper limit of the reactive energy generated by the electric generator of node j at time t through the coal,

$${\underline{Q}}_{j , t}^{G}$$

is a lower limit of the reactive energy generated by the electric generator of node j at time t through the natural gas, and

$${\overline{Q}}_{j , t}^{G}$$

is an upper limit of the reactive energy generated by the electric generator of node j at time t through the natural gas.

Heat supply network side: including mass flow conservation, temperature-pressure coupling equations, and heat exchanger efficiency constraints, represented as:

$$\begin{matrix}{m}_{k , t}^{in} - {m}_{k , t}^{out} = {\sum }_{l : k \to l} {m}_{kl , t} - {\sum }_{j : j \to k} {m}_{jk , t} \\ {P}_{k , t}^{S} - {P}_{l , t}^{S} = {Ψ}_{kl} {m}_{kl , t}^{2} \\ {P}_{l , t}^{R} - {P}_{k , t}^{R} = {Ψ}_{lk} {m}_{lk , t}^{2} \\ {P}_{k , t}^{S} - {P}_{k , t}^{R} = {Ψ}_{k} {( {m}_{k , t}^{out} )}^{2} \\ Δ H = c \cdot {m}_{k , t}^{out} \cdot ( {T}_{k , t}^{S} - {T}_{k , t}^{R} ) \\ {\underline{m}}_{kl , t} \leq {m}_{kl , t} \leq {\overline{m}}_{kl , t} \\ \underline{m} \leq {m}_{k , t}^{in , out} \leq \overline{m} \\ {\underline{P}}_{k}^{S , R} \leq {P}_{k}^{S , R} \leq {\overline{P}}_{k}^{S , R} \\ {\underline{T}}_{k}^{S , R} \leq {T}_{k}^{S , R} \leq {\overline{T}}_{k}^{S , R}\end{matrix}$$

where:

$${m}_{k , t}^{in} , {m}_{k , t}^{out}$$

are mass flow rates of injected water and outflow water at node k at time t, respectively; and m_{kl,t}, m_{jk,t} are a mass flow rate of the water flowing in a pipeline from node k to node l at time t and a mass flow rate of the water flowing in the pipeline from node j to node k at time t, respectively;
flowing of the water between nodes in a heat supply pipeline is driven by a pressure intensity, and a pressure intensity difference between the nodes determines the mass flow rate in the pipeline; wherein

$${P}_{k , t}^{S} , {P}_{l , t}^{S}$$

are pressure intensities of nodes k and l in a water supply pipeline at time t, respectively, Ψₖₗ represents a friction factor of pipeline kl, and m_{kl,t} represents the mass flow rate of the water in pipeline kl at time t;

$${P}_{k , t}^{R} , {P}_{l , t}^{R}$$

are pressure intensities at nodes k and I in a water return pipeline at time t, respectively, Ψₗₖ represents a friction factor of pipeline lk, and m_{lk,t} represents the water mass flow rate of pipeline lk at time t;

$${P}_{k , t}^{S} , {P}_{k , t}^{R}$$

are pressure intensities at node k in water supply and water return networks at time t, respectively, and Ψₖ is the pipeline friction factor;
ΔH is exchanged heat; constraints of upper and lower limits of the mass flow rate of water flow passing through the pipeline: m_{kl,t}, m̅_{kl,t} are a lower limit and an upper limit of the mass flow rate of the water flow passing through the pipeline, respectively;
constraints of upper and lower limits of the mass flow rate of the water flow at injection and outflow nodes: m, m̅ are a lower limit and an upper limit of the mass flow rate, respectively;

$${\underline{P}}_{k}^{S} , {\overline{P}}_{k}^{S}$$

are a lower limit and an upper limit of the pressure intensity at heat supply node k, respectively; and

$${\underline{P}}_{k}^{R} , {\overline{P}}_{k}^{R}$$

are a lower limit and an upper limit of the pressure intensity at water return node k, respectively;

$${\underline{T}}_{k}^{R} , {\overline{T}}_{k}^{R}$$

are a lower limit and an upper limit of the temperature at heat supply node k, respectively; and

$${\underline{P}}_{k}^{S} , {\overline{P}}_{k}^{S}$$

are a lower limit and an upper limit of the temperature at water return node k, respectively.

Gas network side: including a temperature drop equation, a flow conservation equation, and a pipeline pressure intensity equation, represented as:

$$\begin{matrix}( {T}_{i} + {T}_{j} ) {f}_{ij}^{2} = ( {P}_{i}^{2} - {P}_{j}^{2} ) Ω \\ \frac{( {T}_{j}^{out} - {T}_{i}^{in} ) {f}_{ij}}{l} + \frac{1}{2} κ ( {T}_{i}^{in} + {T}_{j}^{out} ) - κ {T}_{e} = 0 \\ \sum {f}_{s} + {\sum }_{j : j \to i} {f}_{ji} = \sum {f}_{D} + {\sum }_{i : i \to k} {f}_{ik} \\ {T}_{j} \cdot {\sum }_{i : i \to j} {f}_{ji} = {\sum }_{i : i \to j} ( {f}_{ij} {T}_{j}^{out} ) \\ {f}_{ij} \leq {f}_{ij} \leq {\overline{f}}_{ij} \\ \underline{P} \leq {P}_{i} \leq \overline{P}\end{matrix}$$

Tᵢ and Pᵢ represent the temperature and pressure intensity at node i, respectively;

$${T}_{j}^{out} and {T}_{i}^{in}$$

represent the temperatures at which the natural gas enters and exits a pipeline, respectively; fᵢⱼ is a natural gas flow rate of the pipeline from node i to node j; Z is the length of the natural gas pipeline, and Tₑ is an environment (soil) temperature outside the pipeline, namely the temperatures at which the natural gas enters and exits the pipeline, respectively;
fₛ, fⱼᵢ, f_{D}, fᵢₖ are the natural gas injected at node i, a mass flow rate flowing from node j to node i, a natural gas load capacity at node i, and a natural gas mass flow rate flowing from node i to node k, respectively;
fᵢⱼ, f̅ᵢⱼ are an lower limit and an upper limit of the natural gas mass flow rate of the pipeline (i, j), respectively;
P, P̅ are a lower limit and an upper limit of the pressure intensity at node i, respectively.

The multi-energy coupling normalization initial model includes a normalized heat exchange equation, a normalized natural gas pressure intensity equation, and a normalized electric power equation;
the normalized heat exchange equation is: ΔĤ=ĉ·\hat{m}·(\hat{T}^{S}−\hat{T}^{R}); the normalized pressure intensity balance equation for a water supply pipeline is: \hat{P}^{S}−\hat{P}^{R}=\hat{Ψ}\hat{m}².
where: ĉ is a normalized specific heat capacity, \hat{m} is a normalized mass flow rate, \hat{T}^{S} is a normalized thermal water supply temperature, \hat{T}^{R} is a normalized thermal water return temperature, \hat{P}^{S} is a normalized thermal water supply pressure intensity, \hat{P}^{R} is a normalized thermal water return pressure intensity, and \hat{Ψ} is a normalized water supply pipeline friction factor.

The flow of natural gas in a pipeline is driven by a pressure intensity difference between pipeline nodes. The pipeline pressure intensity equation, after being standardized, can be represented as:

$$( {\hat{T}}_{i} + {\hat{T}}_{j} ) {\hat{f}}_{ij}^{2} = ( {p}_{i}^{2} - {\hat{p}}_{j}^{2} ) \hat{Ω}$$

where: \hat{T}ᵢ, \hat{p}ᵢ are normalized temperature and pressure intensity of node i respectively, \hat{T}ⱼ, \hat{p}ⱼ are normalized temperature and pressure intensity of node j respectively, \hat{f}ᵢⱼ is a normalized natural gas flow rate of the pipeline from node i to node j, and \hat{Ω} is a normalized natural gas pressure intensity constant.

As natural gas flows through the pipeline, the temperature of natural gas also changes. A temperature change model of natural gas in the pipeline is represented as:

$$\frac{( {\hat{T}}_{j}^{out} - {\hat{T}}_{i}^{in} ) {\hat{f}}_{ij}}{l} + \frac{1}{2} \hat{κ} ( {\hat{T}}_{i}^{in} + {\hat{T}}_{j}^{out} ) - \hat{κ} {\hat{T}}_{e} = 0$$

where: l is the length of the natural gas pipeline, k is a normalized temperature constant, \hat{T}ₑ is a normalized environmental (soil) temperature outside the pipeline, and

$${\hat{T}}_{i}^{in} , {\hat{T}}_{j}^{out}$$

are the temperatures at which the natural gas enters and exits the pipeline (i, j) (both are normalized temperatures). The temperature at which the natural gas enters the pipeline (i, j) is the temperature of the natural gas at node i, that is:

$${\hat{T}}_{i} = {\hat{T}}_{i}^{in}$$

If node j is only connected to node i, the temperature of the natural gas flowing out of the pipeline (i, j) is the temperature of node j, that is:

$${\hat{T}}_{j} =$$

If node j connects to multiple nodes, the natural gas temperature at node j is the average temperature of the gas flowing out of the multiple nodes. According to the first law of thermodynamics, it can be represented as:

$${\hat{T}}_{j} = \frac{{\sum }_{i : i \to j} {\hat{f}}_{ij} {\hat{T}}_{j}^{out}}{{\sum }_{i : i \to j} {\hat{f}}_{ij}} , i ∈ π$$

where, π represents a set of all nodes connecting node j.

Step S3: calculating dynamic balance factors of a heat supply network and a water return network;
the dynamic balance factors include a temperature balance factor σ and a pressure balance factor

$$φ , σ = \frac{{T}^{S}}{{T}^{R}} , φ = \frac{{P}^{R}}{{P}^{S}} ;$$

the multi-energy coupling normalization model includes a coupled heat exchange equation, a coupled natural gas pressure intensity equation, and a coupled electric power equation;
the coupled heat exchange equation is: ΔĤ=ĉ·\hat{m}·(\hat{T}^{S}−σ\hat{T}^{R}); the coupled pressure intensity balance equation for a water supply pipeline is: \hat{P}^{S}−φ\hat{P}^{R}=\hat{Ψ}\hat{m}².

For the coupling model, convex optimization (such as CVX) or mixed integer programming (such as Gurobi) solvers are used, supporting efficient solution for both fixed flow (linear models) and variable flow (nonlinear models) modes;
step S4: based on the dynamic balance factors, modifying the multi-energy coupling normalization initial model to obtain the multi-energy coupling normalization model.

### Embodiment 2

The present application provides a system for constructing a multi-energy coupling normalization model, including:
an acquisition unit, used to acquire actual values;
a calculation unit, used to calculate derived reference values, normalized values, and dynamic balance factors;
a first modeling unit, used to construct an initial target model according to independent reference values and the derived reference values;
a second modeling unit, used to generate a multi-energy coupling normalization initial model according to the initial target model and the normalized values; and
a third modeling unit, used to generate a multi-energy coupling normalization model according to the normalization model and the dynamic balance factors.

### Embodiment 3

To solve the problems in the prior art, the present disclosure provides a computer-readable storage medium, including a stored program, wherein, when the program is running, a device where the computer-readable storage medium is located is controlled to execute the method for constructing the multi-energy coupling normalization model described in Embodiment 1.

It is understood that the systems, devices, modules or units described in the above embodiments may be implemented by computer chips or entities, or by products with certain functions. A typical implementation device is a computer, which can take the form of a personal computer, laptop computer, personal digital assistant, tablet computer, wearable device, or any combination of these devices.

In a typical configuration, a computer includes one or more processors (CPU), input/output interfaces, network interfaces, and memory.

The memory may include a non-permanent memory, a random access memory (RAM) and/or a non-volatile memory and other forms in computer-readable media, such as a read-only memory (ROM) or flash RAM. The memory is an example of a computer-readable medium.

Computer-readable media include permanent and non-permanent, removable and non-removable media, and information storage can be achieved by any method or technology. Information may be computer-readable instructions, data structures, program modules, or other data. Examples of the computer storage media include, but are not limited to, phase change random access memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile optical disc (DVD) or other optical storage, magnetic tape, disk storage, quantum memory, graphene-based storage media or other magnetic storage devices, or any other non-transmission medium that can be used to store information that can be accessed by a computing device. As defined in this article, the computer-readable media do not include transitory media, such as modulated data signals and carrier waves.

It should also be noted that the terms “comprising”, “including”, or any other variations thereof are intended to cover non-exclusive inclusion, such that a process, method, commodity, or apparatus that comprises a list of elements includes not only those elements but also other elements not expressly listed, or elements inherent to such process, method, commodity, or apparatus. Without further restrictions, an element defined by the phrase “comprising a . . . ” does not exclude the presence of other identical elements in the process, method, commodity, or apparatus that includes said element.

It should be understood that although the terms first, second, third, etc. may be used to describe various information in one or more embodiments of this specification, such information should not be limited to these terms. These terms are only used to distinguish information of the same type from one another. For example, without departing from the scope of one or more embodiments of this specification, the first information may also be referred to as the second information, and similarly, the second information may also be referred to as the first information. Depending on the context, the word “if” as used here can be interpreted as “when”, “at the time when”, or “in response to determining that”.

The above description is merely a preferred embodiment of one or more embodiments of this specification and is not intended to limit the scope of one or more embodiments of this specification. Any modifications, equivalent substitutions, improvements, etc., made within the spirit and principles of one or more embodiments of this specification should be included within the protection scope of one or more embodiments of this specification.

What is claimed is:

1. A method for constructing a multi-energy coupling normalization model, comprising the following steps:
step S1: selecting independent reference values for constructing a multi-energy coupling normalization model and setting parameters, obtaining an actual value corresponding to each parameter, and based on the reference values and the actual values, normalizing the actual values to obtain a normalized value of each parameter; wherein
in step S1, the reference values comprise the independent reference values and derived reference values, and the selected independent reference values are as follows: power S, voltage squared value V, mass flow rate m, thermal water supply temperature T^{S}, thermal water return temperature T^{R}, thermal water supply pressure intensity P^{S}, thermal water return pressure intensity P^{R}, natural gas temperature T^{G}, and natural gas pressure intensity P^{G};
calculation formulas of the derived reference values are as follows:
$$\begin{matrix}Z = V / S \\ I = {S}^{2} / V \\ {T}^{loss} = m \\ c = S / ( {mT}^{S} ) \\ Ψ = {P}^{S} / {m}^{2} \\ Γ = {P}^{S} / {m}^{2} \\ ρ = {mP}^{s} / S \\ Ω = ( {T}^{G} \cdot {m}^{2} ) / {( {P}^{G} )}^{2} \\ κ = m\end{matrix}$$
where: Z is impedance, I is a current squared value, T^{loss} is a thermal temperature loss factor, c is a specific heat capacity, Ψ is a thermal pipeline friction factor, Γ is a thermal heat exchanger fiction factor, p is a thermal water density, Ω is a natural gas pressure constant, and κ is a natural gas temperature constant;
step S2: establishing an initial target model with a goal of minimizing overall energy cost, and generating a multi-energy coupling normalization initial model by combining the normalized value of each parameter in step S1 with the initial target model; wherein
in step S2, the initial target model is represented as:
$$min J = α C + β G$$
where: C is the quantity of coal, G is the quantity of natural gas, α is a price per unit of coal, and β is a price per unit of natural gas;
constraints are established in the initial target model:
power grid side: including node power balance, voltage/current limits, and line power flow constraints, represented as:
$${P}_{j , t} = {\sum }_{k : j \to k} {P}_{jk , t} - {\sum }_{i : i \to j} ( {P}_{ij , t} - {r}_{ij} {l}_{ij , t} ) , k ∈ \text{?} , i ∈ ℵ$$
$${Q}_{j , t} = {\sum }_{k : j \to k} {Q}_{jk , t} - {\sum }_{i : i \to j} ( {Q}_{ij , t} - {x}_{ij} {l}_{ij , t} ) , k ∈ \text{?} , i ∈ ℵ$$
$${v}_{j , t} = {v}_{i , t} - 2 ( {r}_{ij} {P}_{ij , t} + {x}_{ij} {Q}_{ij , t} ) + ( {r}_{ij}^{2} + {x}_{ij}^{2} ) {l}_{ij , t}$$
$${‖ \begin{matrix}\begin{matrix}2 {P}_{ij , t} \\ 2 {Q}_{ij , t}\end{matrix} \\ {l}_{ij , t} - {v}_{i , t}\end{matrix} ‖}_{2} \leq {l}_{ij , t} + {v}_{i , t}$$
$${\underline{v}}_{j} \leq {v}_{j , t} \leq {\overline{v}}_{j}$$
$$0 \leq {l}_{ij , t} \leq {\overline{l}}_{ij , t}$$
$${P}_{j , t} = {P}_{j , t}^{C} + {P}_{j , t}^{G} - {P}_{j , t}^{D}$$
$${Q}_{j , t} = {Q}_{j , t}^{C} + {Q}_{j , t}^{G} - {Q}_{j , t}^{D}$$
$${\underline{P}}_{j , t}^{C , G} \leq {P}_{j , t}^{C , G} \leq {\overline{P}}_{j , t}^{C , G}$$
$${\underline{Q}}_{j , t}^{C , G} \leq {Q}_{j , t}^{C , G} \leq {\overline{Q}}_{j , t}^{C , G}$$
where: P_{j,t} is an active power of node j at time t, P_{jk,t} is an active power flowing from node j to node k, P_{ij,t} is an active power flowing from node i to node j, rᵢⱼ is resistance of a line connecting nodes i and j, l_{ij,t} is a square of a current value of the line connecting nodes i and j at time t, [symbol] is a set of nodes from which the power flows out of node j, and [symbol] is a set of nodes from which the power flows to node j;
Q_{j,t} is a reactive load of node j at time t, Q_{jk,t} is a reactive power flowing from node j to node k, Q_{ij,t} is a reactive power flowing from node i to node j, and xᵢⱼ is reactance on the line connecting nodes i and j;
v_{i,t} is a square of a voltage value of node i at time t, and v_{j,t} is a square of a voltage value of node j at time t;
vⱼ is a lower limit of the squared value of the voltage; v̅ⱼ is an upper limit of the squared value of the voltage;
l̅_{ij,t} is a squared value of a maximum current on line ij;
$${P}_{j , t}^{C}$$
is active energy generated by node j consuming the coal at time t,
$${P}_{j , t}^{G}$$
is active energy generated by node j consuming the natural gas at time t, and
$${P}_{j , t}^{D}$$
is an active load capacity of node j at time t;
$${Q}_{j , t}^{C}$$
is reactive energy generated by node j consuming the coal at time t,
$${Q}_{j , t}^{G}$$
is reactive energy generated by node j consuming the natural gas at time t, and
$${Q}_{j , t}^{D}$$
is a reactive load capacity of node j at time t;
$${\underline{P}}_{j , t}^{{C}_{}}$$
is a lower limit of the active energy generated by an electric generator of node j at time t through the coal,
$${\overline{P}}_{j , t}^{{C}_{}}$$
is an upper limit of the active energy generated by the electric generator of node j at time t through the coal,
$${\underline{P}}_{j , t}^{{G}_{}}$$
is a lower limit of the active energy generated by the electric generator of node j at time t through the natural gas, and
$${\overline{P}}_{j , t}^{{G}_{}}$$
is an upper limit of the active energy generated by the electric generator of node j at time t through the natural gas;
$${\underline{Q}}_{j , t}^{C}$$
is a lower limit of the reactive energy generated by the electric generator of node j at time t through the coal,
$${\overline{Q}}_{j , t}^{C}$$
is an upper limit of the reactive energy generated by the electric generator of node j at time t through the coal,
$${\underline{Q}}_{j , t}^{G}$$
is a lower limit of the reactive energy generated by the electric generator of node j at time t through the natural gas, and
$${\overline{Q}}_{j , t}^{G}$$
is an upper limit of the reactive energy generated by the electric generator of node j at time t through the natural gas;
heat supply network side: including mass flow conservation, temperature-pressure coupling equations, and heat exchanger efficiency constraints, represented as:
$${m}_{k , t}^{in} - {m}_{k , t}^{out} = {\sum }_{l : k \to l} {m}_{kl , t} - {\sum }_{j : j \to k} {m}_{jk , t}$$
$${P}_{k , t}^{S} - {P}_{l , t}^{S} = {Ψ}_{kl} {m}_{kl , t}^{2}$$
$${P}_{l , t}^{R} - {P}_{k , t}^{R} = {Ψ}_{lk} {m}_{lk , t}^{2}$$
$${P}_{k , t}^{S} - {P}_{k , t}^{R} = {{Ψ}_{k} ( {m}_{k , t}^{out} )}^{2}$$
$$Δ H = c \cdot {m}_{k , t}^{out} \cdot ( {T}_{k , t}^{S} - {T}_{k , t}^{R} )$$
$${\underline{m}}_{kl , t} \leq {m}_{kl , t} \leq {\overline{m}}_{kl , t}$$
$$\underline{m} \leq {m}_{k , t}^{in , out} \leq \overline{m}$$
$${\underline{P}}_{k}^{S , R} \leq {P}_{k}^{S , R} \leq {\overline{P}}_{k}^{S , R}$$
$${\underline{T}}_{k}^{S , R} \leq {T}_{k}^{S , R} \leq {\overline{T}}_{k}^{S , R}$$
where:
$${m}_{k , t}^{in} , {m}_{k , t}^{out}$$
are mass flow rates of injected water and outflow water at node k at time t, respectively; and m_{kl,t}, m_{jk,t} are a mass flow rate of the water flowing in a pipeline from node k to node l at time t and a mass flow rate of the water flowing in the pipeline from node j to node k at time t, respectively;
flowing of the water between nodes in a heat supply pipeline is driven by a pressure intensity, and a pressure intensity difference between the nodes determines the mass flow rate in the pipeline; wherein
$${P}_{k , t}^{S} , {P}_{l , t}^{S}$$
are pressure intensities of nodes k and I in a water supply pipeline at time t, respectively, Ψₖₗ represents a friction factor of pipeline kl, and m_{kl,t} represents the mass flow rate of the water in pipeline kl at time t;
$${P}_{k , t}^{R} , {P}_{l , t}^{R}$$
are pressure intensities at nodes k and I in a water return pipeline at time t, respectively, Ψₗₖ represents a friction factor of pipeline lk, and m_{lk,t} represents the water mass flow rate of pipeline lk at time t;
$${P}_{k , t}^{S} , {P}_{k , t}^{R}$$
are pressure intensities at node k in water supply and water return networks at time t, respectively, and Ψₖ is the pipeline friction factor;
ΔH is exchanged heat; constraints of upper and lower limits of the mass flow rate of water flow passing through the pipeline: m_{kl,t}, m̅_{kl,t} are a lower limit and an upper limit of the mass flow rate of the water flow passing through the pipeline, respectively;
constraints of upper and lower limits of the mass flow rate of the water flow at injection and outflow nodes: m, m̅ are a lower limit and an upper limit of the mass flow rate, respectively;
$${\underline{P}}_{k}^{S} , {\overline{P}}_{k}^{S}$$
are a lower limit and an upper limit of the pressure intensity at heat supply node k, respectively; and
$${\underline{P}}_{k}^{R} , {\overline{P}}_{k}^{R}$$
are a lower limit and an upper limit of the pressure intensity at water return node k, respectively;
$${\underline{T}}_{k}^{S} , {\overline{T}}_{k}^{S}$$
are a lower limit and an upper limit of the temperature at heat supply node k, respectively; and
$${\underline{T}}_{k}^{R} {\overline{T}}_{k}^{R}$$
are a lower limit and an upper limit of the temperature at water return node k, respectively;
gas network side: including a temperature drop equation, a flow conservation equation, and a pipeline pressure intensity equation, represented as:
$$( {T}_{i} + {T}_{j} ) {f}_{ij}^{2} = ( {P}_{i}^{2} - {P}_{j}^{2} ) Ω$$
$$\frac{( {T}_{j}^{out} - {T}_{i}^{in} ) {f}_{ij}}{l} + \frac{1}{2} κ ( {T}_{i}^{in} + {T}_{j}^{out} ) - κ {T}_{e} = 0$$
$$\sum {f}_{s} + {\sum }_{j : j \to i}^{} {f}_{ji} = \sum {f}_{D} + {\sum }_{i : i \to k}^{} {f}_{ik}$$
$${T}_{j} \cdot {\sum }_{i : i \to j}^{} {f}_{ij} = {\sum }_{i : i \to j}^{} ( {f}_{ij} {T}_{j}^{out} )$$
$${\underline{f}}_{ij} \leq {f}_{ij} \leq {\overline{f}}_{ij}$$
$$\underline{P} \leq {P}_{i} \leq \overline{P}$$
Tᵢ and Pᵢ represent the temperature and pressure intensity at node i, respectively;
$${T}_{j}^{out}$$
and
$${T}_{i}^{in}$$
represent the temperatures at which the natural gas enters and exits a pipeline, respectively; fᵢⱼ is a natural gas flow rate of the pipeline from node i to node j; l is the length of the natural gas pipeline, and Tₑ is a soil temperature outside the pipeline;
fₛ, fⱼᵢ, f_{D}, fᵢₖ are the natural gas injected at node i, a mass flow rate flowing from node j to node i, a natural gas load capacity at node i, and a natural gas mass flow rate flowing from node i to node k, respectively;
fᵢⱼ, f̅ᵢⱼ are an lower limit and an upper limit of the natural gas mass flow rate of the pipeline (i, j), respectively;
P, P̅ are a lower limit and an upper limit of the pressure intensity at node i, respectively;
where: a heat exchange equation is: ΔH=c·m·(T^{S}−T^{R}); a pressure intensity balance equation for a water supply pipeline is: P^{S}−P^{R}=Ψ²;
step S3: calculating dynamic balance factors of a heat supply network and a water return network; and
step S4: based on the dynamic balance factors, modifying the multi-energy coupling normalization initial model to obtain the multi-energy coupling normalization model.

2. The method for constructing the multi-energy coupling normalization model according to claim 1, wherein, in step S3, a normalized heat exchange equation is: ΔĤ=ĉ·\hat{m}·(\hat{T}^{S}−\hat{T}^{R}); a normalized pressure intensity balance equation for a water supply pipeline is: \hat{P}^{S}−\hat{P}^{R}=\hat{Ψ}\hat{m}²;
where: ĉ is a normalized specific heat capacity, \hat{m} is a normalized mass flow rate, \hat{T}^{S} is a normalized thermal water supply temperature, \hat{T}^{R} is a normalized thermal water return temperature, \hat{P}^{S} is a normalized thermal water supply pressure intensity, \hat{P}^{R} is a normalized thermal water return pressure intensity, and \hat{Ψ} is a normalized water supply pipeline friction factor.

3. The method for constructing the multi-energy coupling normalization model according to claim 2, wherein, in step S4, the dynamic balance factors comprise a temperature balance factor σ and a pressure balance factor φ,
$$σ = \frac{{T}^{S}}{{T}^{R}} , φ = \frac{{P}^{R}}{{P}^{S}} ;$$
a coupled heat exchange equation is: ΔĤ=ĉ·\hat{m}·(\hat{T}^{S}−σ\hat{T}^{R}); a coupled pressure intensity balance equation for the water supply pipeline is: \hat{P}^{S}−φ\hat{P}^{R}=\hat{Ψ}\hat{m}².

4. The method for constructing the multi-energy coupling normalization model according to claim 1, wherein, in step S2, the natural gas flows from node i to node j, and a natural gas pressure intensity equation is:
$$( {T}_{i} + {T}_{j} ) {f}_{ij}^{2} = ( {p}_{i}^{2} - {p}_{j}^{2} ) Ω$$
where: Tᵢ is the temperature of node i, Tⱼ is the temperature of node j, pᵢ is the pressure intensity of node i, pⱼ is the pressure intensity of node j, and fᵢⱼ is the natural gas flow rate of the pipeline from node i to node j.

5. The method for constructing the multi-energy coupling normalization model according to claim 4, wherein a normalized natural gas pressure intensity equation is:
$$( {\hat{T}}_{i} + {\hat{T}}_{j} ) {\hat{{f}_{ij}}}^{2} = ( {\hat{p}}_{i}^{2} - {\hat{p}}_{j}^{2} ) \hat{Ω}$$
where: \hat{T}ᵢ is a normalized temperature of node i, \hat{T}ⱼ is a normalized temperature of node j, \hat{p}ᵢ is a normalized pressure intensity of node i, \hat{p}ⱼ is a normalized pressure intensity of node j, \hat{f}ᵢⱼ is a normalized natural gas flow rate of the pipeline from node i to node j, and \hat{Ω} is a normalized natural gas pressure intensity constant.

6. The method for constructing the multi-energy coupling normalization model according to claim 1, wherein, in step S1, a calculation formula of the normalized value is
$$normalized value = \frac{actual value}{reference value} ,$$
and the reference value is either the independent reference value or the derived reference value.

7. A system for constructing a multi-energy coupling normalization model, comprising:
an acquisition unit, used to acquire actual values;
a calculation unit, used to calculate derived reference values, normalized values, and dynamic balance factors;
a first modeling unit, used to construct an initial target model according to independent reference values and the derived reference values;
a second modeling unit, used to generate a multi-energy coupling normalization initial model according to the initial target model and the normalized values; and
a third modeling unit, used to generate a multi-energy coupling normalization model according to the normalization model and the dynamic balance factors, wherein the multi-energy coupling normalization model is the multi-energy coupling normalization model constructed by the construction method described in claim 1.

8. A computer-readable storage medium, comprising a stored program, wherein, when the program is running, a device where the computer-readable storage medium is located is controlled to execute the method for constructing the multi-energy coupling normalization model according to claim 1.
